(19) United States
(12) Patent Application Publication
(10) Pub. No.: US 2018/0308021 A1
(43) Pub. Date: Oct. 25, 2018

(54) AFTER-SALES ORIENTED SYSTEM PLATFORM WITH BUSINESS MODELING FUNCTIONS AND COMMERCIAL VALUES

(71) Applicant: POWER INTERNATIONAL CHEMICAL & OIL CORPORATION, Tainan (TW)

(72) Inventor: Po-Wen KO, Tainan (TW)

(73) Assignee: POWER INTERNATIONAL CHEMICAL & OIL CORPORATION, Tainan (TW)

(21) Appl. No.: 15/592,616

(22) Filed: May 11, 2017

(30) Foreign Application Priority Data
Apr. 19, 2017 (TW) 106113164

(51) Int. Cl. G06Q 10/06; G06F 17/30

(52) U.S. Cl. CPC G06Q 10/067; G06F 17/30943

(57) ABSTRACT

An after-sales system platform provides business modeling functions to enhance commercial values as a measure for deriving business direction, and includes multiple front-end data providing units, a cloud platform and a client service server. The front-end data providing units provide relevant information. The cloud platform has multiple category databases and an information screening unit and categorizes the relevant information and stores the relevant information in the respective category databases. The client service server acquires categorized information through the information screening unit by request. The categorized information can be used for a multi-oriented business model including service policy making, business assessment, and research and development management. The system platform employs innovative concepts of vehicles and remotely piloted vehicles and is implemented on the basis of an on-board diagnostic II.

### BACKGROUND OF THE INVENTION

### 1. Field of the Invention

The present invention relates to a system platform and, more particularly, to an after-sales system platform providing business modeling functions and enhancing commercial values.

### 2. Description of the Related Art

Conventional business models tend to be oriented to classification of technologies and products, and such classification makes the fields of manufacture, sales and maintenance independent and less closely correlated. Although such business concepts create many different types of industries and employed population, the resulting commercial values are not high. In the era of fast information exchange and intense competition around, the competitive edge and influence required for business survival could not be solely gained from same type of industry because suppliers, buyers and even all kinds of potential competitors are all involved in the new type of business model. As a result, the conventional less closely correlated and self-sufficient business models lead to the issue of competition deficiency.

Take vehicle industry as an example. After vehicle manufacturers build vehicles, vehicle-related businesses are quite diversified and stretch across vehicle sales, vehicle maintenance, supplies of vehicle accessories and so on. Just take vehicle maintenance as an example; there are many maintenance providers representative of parts from different parts manufacturers for vehicle owners to choose. It is natural that there are even more vehicle-related businesses out there in the market. In addition to vehicles considered as the most ordinary transportation tools, the necessities of life including food, clothing, housing, transportation, education, and entertainment are more or less linked to the vehicle-related businesses. As each industry only promotes its businesses within their narrow and limited information channels, the after-sales commercial values of vehicles are inevitably bounded.

Besides regular vehicles, transportation tools also include motorcycles, bicycles, and remote piloted vehicles under rapid development. As those transportation tools play an important factor to many aspects of people's daily life during national development of every country, reconsidering current information integration concepts, what we lack is an after-sale system platform in the vehicle industry, which can create more innovative business thinking and provide more business modeling functions.

### SUMMARY OF THE INVENTION

An objective of the present invention is to provide an after-sales system platform with business modeling functions and commercial values constructed with concepts of vehicles and remotely piloted vehicles (RPV) and implemented on the basis of the on-board diagnostic II (OBD II) system.

To achieve the foregoing objective, the after-sales system platform with business modeling functions and commercial values includes multiple front-end data providing units, a client service server and a cloud platform.

Each front-end data providing unit provides multiple pieces of front-end information. Each piece of front-end information corresponds to an attribute.

The client service server generates a screening request according to user's operation. The screening request corresponds to at least one of the multiple attributes of the multiple pieces of front-end information provided by the multiple front-end data providing units.

The cloud platform is connected to the multiple front-end data providing units and the client service server and has multiple category databases and an information screening unit.

The multiple category databases store the multiple pieces of front-end information provided by the multiple front-end data providing units. The multiple pieces of front-end information stored in each category database have an identical attribute.

The information screening unit reads corresponding pieces of front-end information from corresponding category databases according to the at least one attribute of the screening request sent from the client service server and sends the corresponding pieces of front-end information to the client service server.

The foregoing front-end data providing units are directly or indirectly linked to vehicles, such that the after-sales system platform can be implemented on the basis of the OBD II installed in the vehicles. By virtue of the system platform, relevant information can be integrated in the cloud platform and categorized in the respective category databases. The client service server further requests for information through the information screening unit to suit for operation of different business models with better commercial values.

The front-end information provided by the multiple front-end data providing units are vehicle information associated with wagons, bicycles, motor vehicles, and RPV. Accordingly, the business modeling functions provided by the after-sales system platform have substantial effectiveness to vehicles and RPV especially. The safety effectiveness allows an RPV to safely drive to a destination.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an after-sales system platform in accordance with the present invention;

FIG. 2 is a functional block diagram of an application for the after-sales system platform in FIG. 1;

FIG. 3 is an operational functional block diagram of the after-sales system platform in FIG. 2;

FIG. 4 is another operational functional block diagram of the after-sales system platform in FIG. 2; and

FIG. 5 is a schematic diagram showing that the after-sales system platform analyzes application sides with big data.

### DETAILED DESCRIPTION OF THE INVENTION

The after-sales system platform providing business modeling functions and enhancing commercial values in accordance with the present invention is applicable to vehicles and other transportation tools. The vehicles here include wagons, bicycles, motor vehicles (motorcycles, trucks, buses), remote piloted vehicles (RPV) and the like. What the present invention intends to emphasize is that the commercial values provided by the present invention is more important to the vehicles, especially the remote piloted vehicles, because of rising need for automatic driving to destination. Hence, the present invention focuses on the vehicles and implements the system platform on the basis of an on-board diagnostic II (OBD II) system. Description of the after-sales system platform is given as follows by using vehicles as an example.

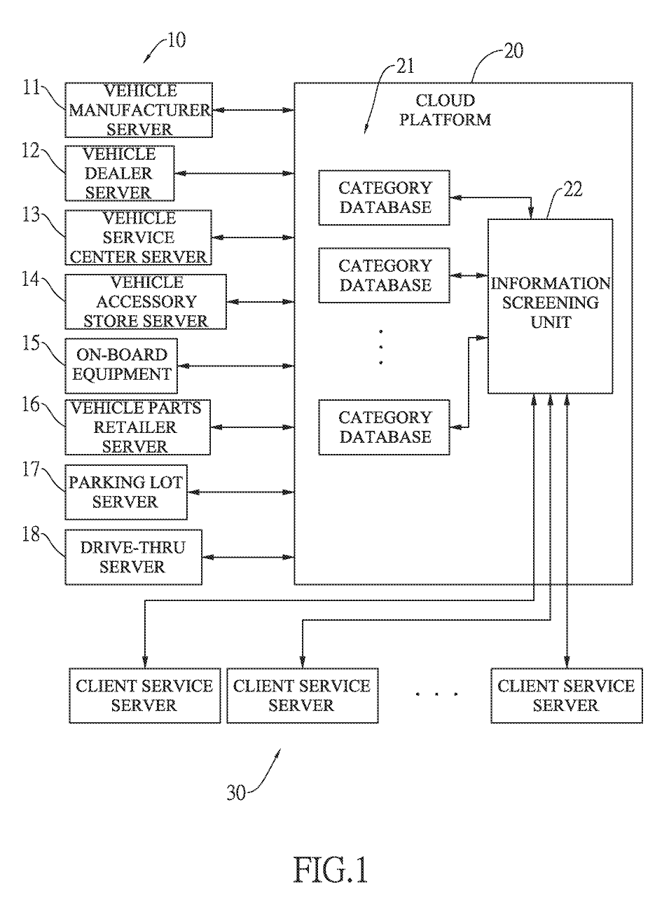

With reference to FIG. 1, the after-sales system platform in accordance with the present invention includes multiple front-end data providing units 10, a cloud platform 20 and multiple client service servers 30. The cloud platform 20 includes multiple category databases and is located between the multiple front-end data providing units 10 and the multiple client service servers 30 to interface with the multiple front-end data providing units 10 and the multiple client service servers 30.

The multiple front-end data providing units 10 contain information directly or indirectly associated with host servers and vehicles themselves. The front-end data providing units 10 are installed in the respective host servers by way of example but not limitation, such as a vehicle manufacturer server 11, a vehicle dealer server 12, a vehicle service center server 13, a vehicle accessory store server 14 for vending accessories inside the vehicles, on-board equipment 15, a vehicle parts retailer server 16, a parking lot server 17 at the vehicle owner's residence or a shopping center for providing parking service to the vehicles, and a drive-thru server 18 for servicing the driver at a drive-thru lane of a catering service. The front-end data providing units 10 may be directly or indirectly linked to the vehicle, such that the after-sales system platform can be implemented by virtue of the OBD II equipped by the vehicle.

Given the vehicle manufacturer server 11 as an example, original information associated with the vehicle is sent to the cloud platform 20 and is taken as basic information for determining various types of subsequent information for the vehicle. Given the vehicle dealer server 12 as an example, information associated with the vehicle owner is sent to the cloud platform 20 for collecting the owner's purchasing habits and gathering other vehicle owners' information from different regions. Given the vehicle service center server 13 as an example, not only can the vehicle's maintenance records be sent to the cloud platform 20, but also particular maintenance experience can be uploaded to the cloud server 20 for the cloud platform 20 to be resourceful in terms of maintenance information. Moreover, spare parts stored in inventory of each vehicle service center can be uploaded to the cloud server 20. Information associated with food, clothing, housing, transportation and entertainment acquired from each vehicle service center can be also uploaded to the cloud platform 20 via the vehicle service center. Thus, the cloud platform 20 can store information relevant to each vehicle owner and acquire relevant information of specific regions through the widely distributed vehicle service centers.

Given the vehicle accessory store server 14 as an example, records of the vehicle owner's purchasing habits, including most-frequently purchased merchandise item, and frequency and amount of purchase, are uploaded to the cloud platform 20. Thus, the cloud platform 20 can similarly store information relevant to each vehicle owner and acquire purchasing habits of consumers shopping in the widely distributed vehicle accessory stores, including information about hot selling items, slow selling items and amount of transaction.

Given the on-board equipment 15 as an example, vehicle-driving states, records of failure and driver behavior information are sent to the cloud platform 20 for the cloud platform 20 to acquire vehicle-driving states and vehicle condition of each vehicle. Depending on make of vehicle and functions of the vehicle, all sorts of information available to the vehicle, including all kinds of information about food, clothing, housing, transportation and entertainment installed by the vehicle owner or embedded in the vehicle system, can be also uploaded to the cloud platform 20.

Given the vehicle parts retailer server 16 as an example, information about items of parts replacement or replacement timing is uploaded to the cloud platform 20 to build up information relevant to parts replacement. Besides, servers with other vehicle-related information can be taken as a front-end data providing unit 10. For example, the parking lot server 17, the drive-thru server 18 or any other host server directly or indirectly related to the vehicles can be taken as a front-end data providing unit 10.

As can be seen from the foregoing description, as long as there is any direct or indirect correlation with vehicles, the vehicle manufacturer server 11, the vehicle dealer server 12, the vehicle service center server 13, the vehicle accessory store server 14, the on-board equipment 15, the vehicle parts retailer's server 16, the parking lot's server 17, the drive-thru server 18 and any host server directly or indirectly related to vehicles, the after-sales system platform can be implemented on the basis of OBD II in the vehicles.

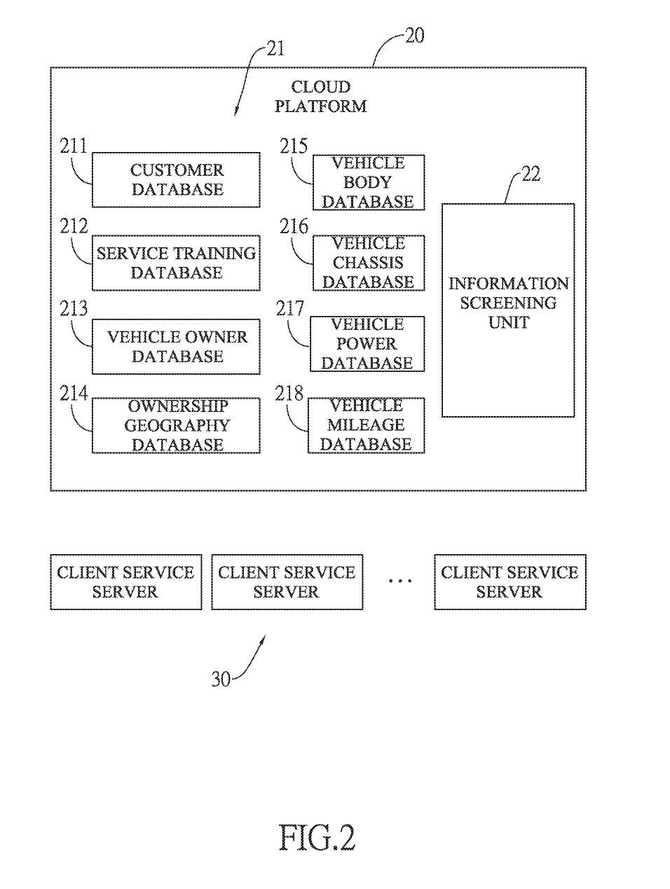

The cloud platform 20 may be constructed by the supplier thereof or by system integrators. Information can be exchanged between the cloud platform 20 and the multiple front-end data providing units 10 by two-way communication, meaning that the multiple front-end data providing units 10 can transmit relevant information to the cloud platform 20 on a real-time basis and after an authentication process, the cloud platform can also forward information pertaining to the multiple front-end data providing units 10 back to the respective host servers. The cloud platform 20 includes multiple category databases 21 and an information screening unit 22. Each category database 21 can be categorized and defined according to a specific application. With reference to FIG. 2, the category databases inside the cloud platform 20 include a customer database 211, a service training database 212, a vehicle owner database 213, an ownership geography database 214, a vehicle body database 215, a vehicle chassis database 216, a vehicle power database 217, and a vehicle mileage database 218. Besides the foregoing databases, databases categorized according to specific applications can be added on demand at any time. Information provided by the front-end data providing units 10 can be collected in different databases according to configuration of the host servers associated with the front-end data providing units 10 or communication paths set up by the cloud platform 20. Alternatively, same information may be stored in multiple different databases for the information requesters to acquire more complete information.

Each client service server 30 may be connected to the information screening unit 22 of the cloud platform 20. When one of the multiple client service servers 30 sends out a screening request, relevant information is read from a corresponding category database 21 according to attribute of the screening request and is transmitted to the client service server 30.

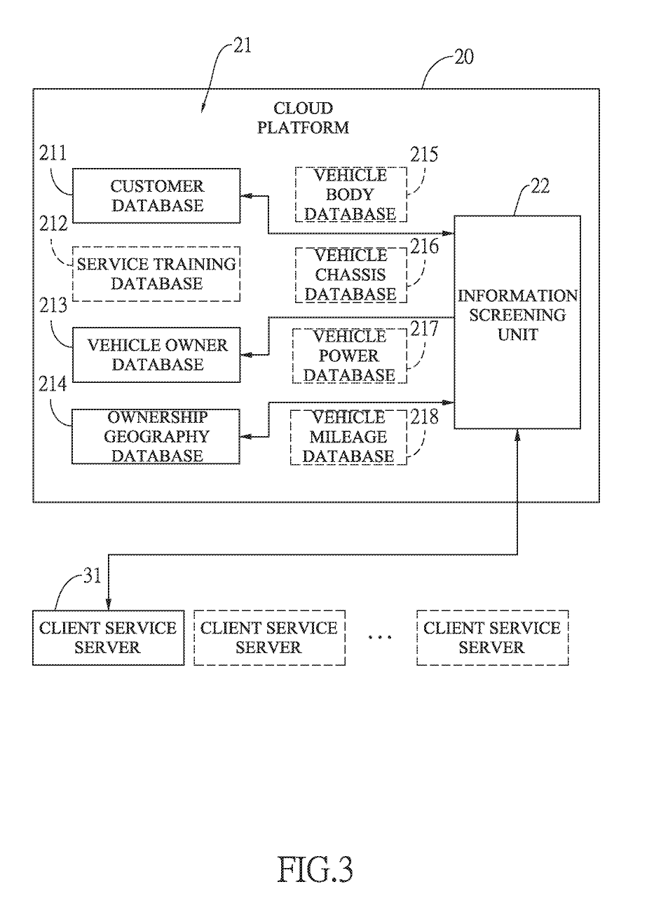

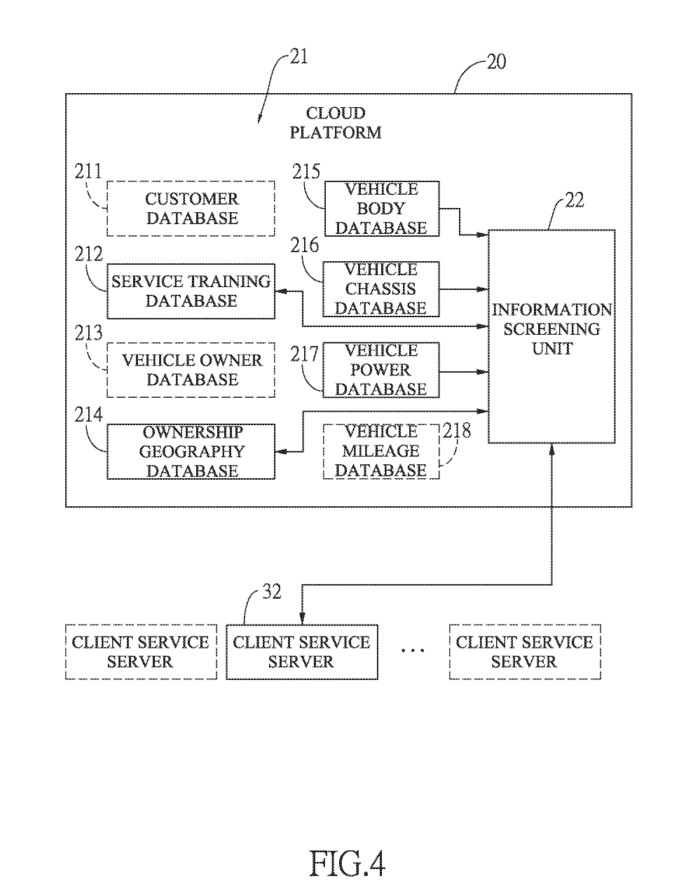

Applications defined by the category databases 21 in the cloud platform 20 can be implemented by the illustration of operation in FIG. 3 or 4. With reference to FIG. 3, one of the client service servers 31 sends a screening request to the information screening unit 22 of the cloud platform 20, and the cloud platform 20 collects information in the customer database 211, the vehicle owner database 213 and the ownership geography database 214, after receiving the screening request, the cloud platform 20 performs the authentication process for identity check of the requester, and when the identity of the requester is authenticated correctly, the cloud platform 20 then transmits the requested information to the client service server 31 through the information screening unit 22.

In view of the multiple front-end data providing units, diversified information can be instantly uploaded to the cloud platform. When any client service server 32 sends out an information request, the cloud platform 20 can then provide analyzed information through an information analysis structure as follows.

If client A intends to set up a vehicle service center in a specific region and the service center also carries accessories inside vehicle for sales, the client A sends a request for information pertinent to maintenance services associated with vehicle owners and accessories purchased in the specific region through one of the client service servers 30. What information that the client A intends to have pertains to information relevant to vehicle owners in the specific region, such as make and model of the vehicle, acceptable cost for repair, preference toward accessories and the like. The consequence is that after the cloud platform 20 provides the requested information in the form of big data and the analysis report to the client A, the client A can determine the feasibility and risk of setting up a vehicle service center in the specific region based on the analysis report.

If client B has already set up a car parking lot in the specific region, because of keen competition from neighboring parking lots, the client B sends a request for information pertinent to maintenance services associated with vehicle owners and where vehicle owners go to for entertainment. After the requested information is acquired, the client B can deal with specific service centers or places of entertainment with favorable terms to provide coupons as a promotion measure for increasing customer flow.

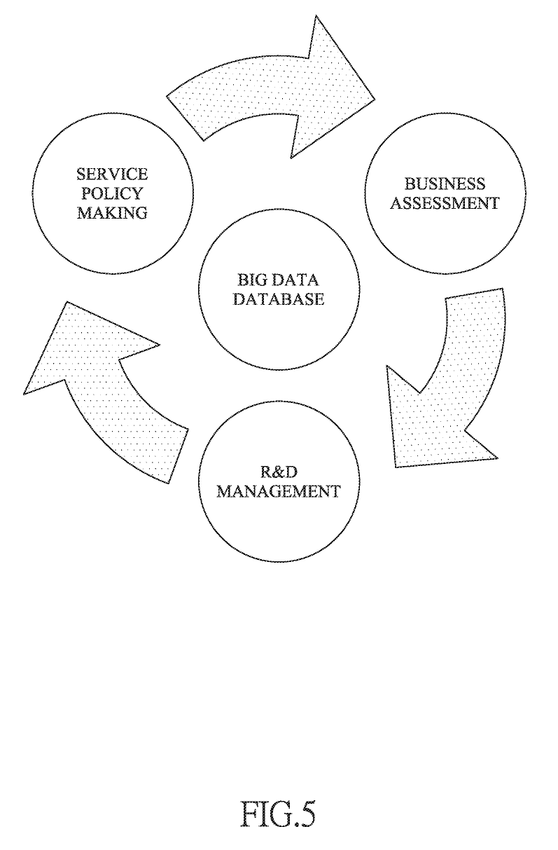

The multiple front-end data providing units can provide sufficient after-sales information of vehicles and vehicle-related information. Information directly or indirectly related to vehicles and information associated with vehicle owners, irrespective of information for vehicles themselves or information for food, clothing, housing, transportation and entertainment associated with vehicle owners, can enter the cloud platform 20 through the multiple front-end data providing units 10. Supposing that the multiple front-end data providing units 10 are directly or indirectly linked to the vehicles, the after-sales system platform in accordance with the present invention can be implemented on the basis of the OBD II. Thus, information can be stored in the relevant category databases 21 through configured paths corresponding to the information to establish a big data database as illustrated in FIG. 5. Each client service server 30 can request for information sent from the cloud platform 20 on demand. Through determination and integration of artificial intelligence, the requested information can be used for service policy making, business assessment and research and development (R&D) management to bring forth business modeling functions and increasing commercial values.

In the case of service policy making, the big data database can be used for intelligent analysis of dynamic business management, which includes analysis about enterprise management policy making, dynamic decision making of corporate, and other decision making. Information for different analyses can be presented in an immediate and multi-oriented fashion, such that various quickly integrated and analyzed reports can be extensively applied to all aspects of management level, client side and business derivation. As far as management level is concerned, information acquired from different analyses can be used for personnel management, internal material flow management, management in other areas and even for dynamic management. As far as the client side is concerned, not only can clients' information be collected, but also purchasing habits and diversified information about food, clothing, housing, transportation and entertainment associated with clients can be gathered so as to achieve instant and complete client service support. As for business promotion, business policy can be adjusted to adapt to variation of the social, political and economic environments and clients' demands, thereby reflecting flexibility in deriving a business model.

Supposing that the big data database is used for business evaluation, type of profession, location of residence or attributes of clients can be accessed from the category databases of the cloud platform. If a new service center needs to be set up in a specific road of a specific county, clients in the region can be analyzed through the specific category databases of the cloud platform to formulate conditions for setting up a service center tailored to the specific region. After the service center is set up, management policies can be dynamically adjusted according to information provided through the cloud platform.

Supposing that the big data database is used for R&D management, the client service server may be from the manufacturer of the vehicle. Thus, the manufacturer can acquire multi-oriented vehicle information, such as maintenance records, wear-out of parts, and owner's preferences for repair services, from the cloud platform, which can be applied as references and basis for future product development to enhance capabilities in R&D and management.

The after-sales system platform with business modeling functions and commercial values in accordance with the present invention can be applied not only to various vehicles but also to other transportation tools. Information directly or indirectly acquired is integrated through the cloud platform to form the big data databases. Those big data databases are further classified for the purpose of service policy making, business assessment, R&D and other commercial applications. Therefore, the entire system platform provides commercial values having substantial effectiveness for business promotion.

Besides the foregoing business modeling functions, the present invention can be applied to the field of RPV with safety concern taken into account. When the present invention is applied to the field of RPV, in addition to the foregoing service policy making, business assessment, R&D and other commercial applications, information associated with movement prior to departure and after arrival of the RPV is collected and analyzed to secure the safety concern and make sure that the RPV safely arrives at the destination.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An after-sales system platform with business modeling functions and commercial values, comprising:
multiple front-end data providing units, each front-end data providing unit being a vehicle information providing unit and providing multiple pieces of front-end information, wherein each piece of front-end information corresponds to an attribute;
a client service server generating a screening request according to user's operation, wherein the screening request corresponds to at least one of the multiple attributes of the multiple pieces of front-end information provided by the multiple front-end data providing units; and
a cloud platform connected to the multiple front-end data providing units and the client service server and having:
multiple category databases storing the multiple pieces of front-end information provided by the multiple front-end data providing units, wherein the multiple pieces of front-end information stored in each category database have an identical attribute; and
an information screening unit reading corresponding pieces of front-end information from corresponding category databases according to the at least one attribute of the screening request sent from the client service server and sending the corresponding pieces of front-end information to the client service server.

2. The after-sales system platform as claimed in claim 1, wherein the multiple pieces of front-end information provided by the multiple front-end data providing units are vehicle information associated with wagons, bicycles, motor vehicles, and remote piloted vehicles (RPV).

3. The after-sales system platform as claimed in claim 2, wherein when the multiple front-end data providing units provide vehicle information, at least two of the multiple front-end data providing units are respectively installed in at least two of a vehicle manufacturer server, a vehicle dealer server, a vehicle service center server, a vehicle accessory store server, on-board equipment, a vehicle parts retailer server, a parking lot server, and a drive-thru server.

4. The after-sales system platform as claimed in claim 3, wherein the vehicle manufacturer server provides original information associated with vehicles.

5. The after-sales system platform as claimed in claim 3, wherein the vehicle service center server provides maintenance records and information associated with food, clothing, housing, transportation and entertainment acquired from vehicle service centers.

6. The after-sales system platform as claimed in claim 3, wherein the vehicle accessory store server provides records of vehicle owners' purchasing habits.

7. The after-sales system platform as claimed in claim 3, wherein the on-board equipment provides vehicle-driving states, records of failure and driver behavior information or information about food, clothing, housing, transportation and entertainment installed by vehicle owners or embedded in a vehicle system.

8. The after-sales system platform as claimed in claim 3, wherein the multiple category databases include at least two of a customer database, a service training database, a vehicle owner database, an ownership geography database, a vehicle body database, a vehicle chassis database, a vehicle power database, and a vehicle mileage database.

9. The after-sales system platform as claimed in claim 4, wherein the multiple category databases include at least two of a customer database, a service training database, a vehicle owner database, an ownership geography database, a vehicle body database, a vehicle chassis database, a vehicle power database, and a vehicle mileage database.

10. The after-sales system platform as claimed in claim 5, wherein the multiple category databases include at least two of a customer database, a service training database, a vehicle owner database, an ownership geography database, a vehicle body database, a vehicle chassis database, a vehicle power database, and a vehicle mileage database.

11. The after-sales system platform as claimed in claim 6, wherein the multiple category databases include at least two of a customer database, a service training database, a vehicle owner database, an ownership geography database, a vehicle body database, a vehicle chassis database, a vehicle power database, and a vehicle mileage database.

12. The after-sales system platform as claimed in claim 7, wherein the multiple category databases include at least two of a customer database, a service training database, a vehicle owner database, an ownership geography database, a vehicle body database, a vehicle chassis database, a vehicle power database, and a vehicle mileage database.

13. The after-sales system platform as claimed in claim 3, wherein the on-board equipment is an on-board diagnostic II (OBD II) system.

14. The after-sales system platform as claimed in claim 4, wherein the on-board equipment is an on-board diagnostic II (OBD II) system.

15. The after-sales system platform as claimed in claim 5, wherein the on-board equipment is an on-board diagnostic II (OBD II) system.

16. The after-sales system platform as claimed in claim 6, wherein the on-board equipment is an on-board diagnostic II (OBD II) system.

17. The after-sales system platform as claimed in claim 7, wherein the on-board equipment is an on-board diagnostic II (OBD II) system.

18. The after-sales system platform as claimed in claim 8, wherein the on-board equipment is an on-board diagnostic II (OBD II) system.

19. The after-sales system platform as claimed in claim 9, wherein the on-board equipment is an on-board diagnostic II (OBD II) system.

20. The after-sales system platform as claimed in claim 10, wherein the on-board equipment is an on-board diagnostic II (OBD II) system.
